(19) United States
(12) Patent Application Publication
(10) Pub. No.: US 2022/0230547 A1
(43) Pub. Date: Jul. 21, 2022

(54) PUD application and protocols for deployment and qualification of independent non-centralized registered autonomous Drone, Quadcopter, Helicopter or UAV with an ESN, SN, MID, Remote ID or FAA registration number

(71) Applicant: Jeffrey Floyd Miller, Germantown, TN (US)

(72) Inventor: Jeffrey Floyd Miller, Germantown, TN (US)

(21) Appl. No.: 17/151,155

(22) Filed: Jan. 16, 2021

(51) Int. Cl. G08G 5/00; B64C 39/02; G05D 1/00; G05D 1/04; G06F 16/9035

(52) U.S. Cl. CPC G08G 5/003; B64C 39/024; G05D 1/0094; G08G 5/0069; G08G 5/006; B64C 2201/141; G05D 1/042; G06F 16/9035; B64C 2201/12; B64C 2201/108; G08G 5/0013

(57) ABSTRACT

An improved system and method to interlink a plurality of independently owned non-centralized registered autonomous aircraft identified by ESN, SN, MID, Remote ID or FAA registration number within a dedicated network for remote route deployment. System is comprised of a web-based application, aircraft identification protocol, aircraft selection protocol, aircraft flight path prioritization protocol and route avoidance protocol that establishes a communication protocol with a qualified aircraft for the purpose of routing to multiple destinations. Methodology includes recognizing a unique identifier to qualify the make, model, flight time, range and maximum payload for an automated aircraft.

### BACKGROUND

Improvements of systems to develop an integrated network to positively identify independent non-centralized registered autonomous aircraft including Drones, Quadcopters, Helicopters and Unmanned Ariel Vehicles (UAVs) by a unique identification has been underdeveloped. The creation of a communication info-structure to coordinate a unified network, interlinking independent non-centralized registered autonomous Drones, Quadcopters, Helicopters and UAVs, capable of responding to data transferred from a server, permitting remote deployment has not been achieved. Under this improved system, a plurality of independently owned non-centralized registered autonomous delivery aircraft including Drones, Quadcopters, Helicopters and UAVs are recognized via a unique identifier including the Electronic Serial Number (ESN), Serial Number (SN), Manufacturing Identification (MID), Remote ID or FAA registration number of the physical Drone, Quadcopter, Helicopter, UAV or peripheral module.

A major hurdle preventing the development of an integrated deployment system can be attributed to a lack of methods designed to facilitate a system to positively identify and link independent non-centralized registered autonomous aircraft including Drones, Quadcopters, Helicopters and UAVs. Lack of development for methods facilitating positive identification of a universal commonality between delivery aircraft including Drones, Quadcopters, Helicopters and UAV's has been the main deterrent in establishing linked communication. Addressing the issue of a delivery network identifying a common identifier can now be solved for both registered and non-registered Drones, Quadcopters, Helicopters and UAVs, with the capability to wirelessly transmit an identifying ESN, SN, MID, Remote ID or FAA registration number.

Wireless identification of an in-network independent non-centralized registered autonomous Drone, Quadcopter, Helicopter or UAV by wirelessly transmitting its assigned ESN, SN, MID, Remote ID or FAA registration number back to a PUD (Pick-up and Delivery) Routing Server, enables the qualification of aircraft and development of an improved PUD application and PUD routing server to receive user inputs.

Enhancements derived from a common aircraft identifier in addition with a PUD routing server to receive user inputs from a web-facing interface server, enable querying a plurality of registered in-network real-time specifications as received from aircraft. Real-time specifications for a plurality of in-network independent non-centralized registered autonomous aircraft enable the development of a system to compute aircraft selection. Systems and protocols unique to the disclosed system and methodology therefore yield an enhanced PUD application.

Further dependent enhancements include the facilitation of a Graphical User Interface (GUI) display of an aircraft selection protocol prioritization data set, derived from the computations of the PUD routing server.

Additionally, independent protocols can be derived from the unique systems emanating from the present disclosure. Identification of aircraft, capable of wirelessly transmitting a unique ESN, SN, MID, Remote ID or FAA registration number provide the foundation for the disclosed unique systems to create a network comprising a plurality of independent non-centralized registered autonomous aircraft. Protocols derived from the network comprising a plurality of independent non-centralized registered autonomous aircraft may include, but not limited to an aircraft identification protocol, aircraft selection protocol, aircraft flight path prioritization protocol and route avoidance protocol.

### SUMMARY

Improved systems and methods for a network facilitating remote deployment of a plurality of independent non-centralized registered autonomous aircraft including Drones, Quadcopters, Helicopters and UAVs are described in detail herein. Embodiments enclosed represent the system infrastructure and process methodology detailing execution of remote aircraft deployment. The infrastructure, as presented in various embodiments detailed herein, can include a system comprised of a plurality of independent non-centralized registered autonomous aircraft equipped with an internal or peripheral module to transmit a unique identifier including an ESN, SN, MID, Remote ID or FAA registration number. Additional equipment to facilitate remote deployment includes a web-interfacing server to receive user inputs and a PUD server whereby a multitude of protocols and executable events can compute, process, transmit and receive delivery routes and flight paths from a plurality of aircraft, thereby linking aircraft into an improved integrated network communication system.

Improved integrated network communication system facilitates receiving and transmitting data to a PUD routing server from a plurality of independent non-centralized autonomous aircraft including Drone, Quadcopter, Helicopter and UAV equipped with an internal or peripheral module via a wireless communication method. Detailed herein are systems and methods for aircraft to recognize other nearby aircraft by an identifier including ESN, SN, MID, Remote ID or FAA registration number for route avoidance and Aircraft-to-Aircraft (ATA) communication as well as the Aircraft Communications Addressing and Reporting System (ACARS) to communicate to ground stations. Additionally, data transmitted or received from the internal or peripheral module may include, but not limited to make, model, weight of aircraft, gross weight, max payload capacity, flight time, battery amperage, hovering time remaining, pick-up routing address, delivery destination address, time of day, time zone, GPS coordinates, altimetry readings, strength of signal readings, accelerometer readings, Inertial Measurement Units (IMU), yaw, pitch, roll and battery level.

Also, included within the present disclosure is an improved PUD application utilizing the improved network of independent non-centralized registered autonomous aircraft, facilitating ATA communication and identification. Present disclosure also details an internet facing web-based PUD application GUI to receive both user inputs by a sender and confirmation by a receiver. Additionally, various process and protocols to facilitate an improved system for remote aircraft deployment are also detailed.

Various processes and protocols enclosed, as presented in various embodiments include protocols for route avoidance, aircraft flight path prioritization, aircraft identification and aircraft selection. Additionally, the present disclosure presents improved methods for identification and qualification of aircraft for deployment, searching or scanning a defined area for a plurality of qualified aircraft, initiating takeoff based on received user inputs, transmission of an executable flight path via a satellite, Wi-Fi or cellular network and recognizing when nearby aircraft enter or leave an area occupied by an aircraft in route.

### BRIEF DESCRIPTION OF THE DRAWINGS

FIG. 1 is the functional block diagram of an exemplary improved system for a PUD application consisting of a GUI receiving user inputs by a sender for independent non-centralized registered autonomous aircraft including Drones, Quadcopters, Helicopters and UAVs for transportation.

FIG. 2 is a flow diagram that illustrates an improved methodology that facilitates a plurality of user inputs from a sender and receiver via a GUI to confirm transaction details.

FIG. 3 is a flow diagram that illustrates an improved system for an aircraft selection protocol from a plurality of independent non-centralized autonomous aircraft identified with a registered ESN, SN, MID, Remote ID or FAA registration number.

FIG. 4 is a functional block diagram of an improved system that facilitates a web-interfacing GUI to initiate a transaction using the PUD application independent non-centralized registered autonomous Drone, Quadcopter, Helicopter or UAV with ESN, SN, MID, Remote ID or FAA registration number.

FIG. 5 is a graphical display of the aircraft selection protocol comprising an overlaid map with all nearby aircraft suited to complete the transaction criteria and a route specific data set emanating from the PUD routing server.

FIG. 6 is a functional block diagram that illustrates an aircraft route avoidance protocol by non-centralized independent autonomous aircraft transmittal of an ESN, SN, MID, Remote ID or FAA registration number.

FIG. 7 is a flow diagram of an exemplary system that facilitates the flight path prioritization protocol by non-centralized independent registered autonomous aircraft transmittal of an ESN, SN, MID, Remote ID or FAA registration number.

FIG. 8 is a flow diagram of an exemplary system that facilitates the route avoidance protocol by non-centralized independent registered autonomous aircraft transmittal of an ESN, SN, MID, Remote ID or FAA registration number.

FIG. 9 is a functional block diagram that illustrates a system for an aircraft internal or peripheral module to transmit an ESN, SN, MID, Remote ID or FAA registration number in a computing embodiment.

### DETAILED DESCRIPTION

The following detailed description illustrates exemplary embodiments by way of example for the present disclosure herein. The Pick-up and Delivery (PUD) application for independent non-centralized registered autonomous aircraft including Drone, Quadcopter, Helicopter or UAV with a unique ESN, SN, MID, Remote ID or FAA registration number is now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Additionally, as used herein, the term “exemplary” is intended to mean serving as an illustration or example of something, and is not intended to indicate a preference.

Further, as used herein, the terms “Drone”, “Quadcopter”, “Helicopter” and “UAV” are intended to be encompassed within the broader hypernym “aircraft”. Additionally, as used herein, the term “identifier” is intended to mean a unique electronically coded identification number or series of text characters to include “Electronic Serial Number (ESN)”, “Serial Number (SN)”, “Manufacturer's Identification (MID)”, “Remote ID” or “FAA registration number” to positively identify individual Drones, Quadcopters, Helicopters and UAVs as defined under the guidance of ISO/IEC CD 22460 and ISO/TC 20/SC 16.

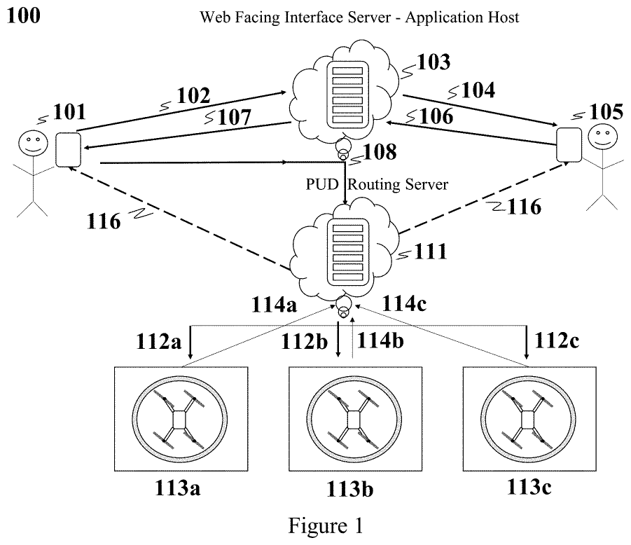

With reference to FIG. 1, an exemplary system 100 that facilitates a consumer to consumer, business to consumer or business to business PUD application for independent non-centralized autonomous registered aircraft including Drones, Quadcopters, Helicopters or UAVs identified by an ESN, SN, MID, Remote ID or FAA registration number. In one embodiment, Sender 101 inputs data onto a web-interfacing application. Sender 101 input data may include, but not limited to an item description including payload available for pick-up, payload gross weight, package spatial dimensions measured by width, height and length as well as availability time for pick-up. Data is then transmitted via output signal 102 onto a Web-interfacing Server 103. Web-interfacing Server 103 processes data and outputs the updated data via output signal 104. The GUI of the web-interfacing application of the Receiver 105 is updated with the data as inputted by the Sender 101 and prompts the Receiver 105 to confirm the transaction. Receiver 105 then confirms or denies the transaction, whereby user inputted data is transmitted via output signal 106 to the Web-interfacing Server 103 and then sent back via data signal 107 to the Sender 101. Sender 101 either confirms, denies or cancels the transaction details via output signal 102 back to the Web-interfacing Server 103. Web-interfacing Server 103 process data from output signal 102 and transmits that confirmation or denial of the transaction data back to the Receiver 105 via output signal 104.

If Sender 101 denies or modifies the transaction, Sender 101 will alter data via the web-interfacing application, thus re-initiating the routine of Receiver 105 confirming transaction details. If Sender 101 accepts the transaction, output signal 102 relays the confirmation back to the Web-interfacing Server 103. Web-interfacing Server 103 will then send output signal 104 back to the Receiver 105. Receiver 105 will then confirm or deny the transaction via the modified output signal 106 back to the Web-interfacing Server 103, whereby the Web-interfacing Server 103 will transmit output signal 107 back to the Sender 101.

In one embodiment, if the Receiver 105 confirms the transaction via the web-interfacing application, the transaction will progress by transmitting the confirmation request via data signal 106 onto the Web-interfacing Server 103, which processes the confirmation data and simultaneously transmit an output data signal 107 to the Sender 101, while also transmitting output data signal 108 to the PUD Routing Server 111.

In another embodiment, if the Receiver 105 confirms the transaction via the web-interfacing application, the transaction will progress by transmitting the confirmation request via data signal 106 onto the Web-interfacing Server 103, which further processes the transaction details by transmitting output data signals 108 to the PUD Routing Server 111.

PUD Routing Server 111 processes data signal 108 and runs an aircraft identification protocol to identify the make, model, gross weight, hovering time, available flight time, max payload capacity, max package size, battery amperage and total flight distance of compatible aircraft possible for deployment, derived from the individual aircraft identifiers within the network of available and registered Drones, Quadcopters, Helicopters and UAVs. After the aircraft identification protocol yields all qualified Drones, Quadcopters, Helicopters and UAVs able to execute the transaction, the PUD Routing Server 111 transmits output data signal 112a, 112b and 112c. Output data signal 112a, 112b and 112c pings each qualified Drone, Quadcopter, Helicopter and UAV available 113a, 113b and 113c, within a specified flight radius, capable of executing travel to the pick-up location, then travel to the drop-off location and travel back to the launch pad location. Each Drone, Quadcopter, Helicopter and UAV available 113a, 113b and 113c transmits output signals 114a, 114b and 114c back to the PUD Routing Server 111. Output signals 114a, 114b and 114c relay data including, but not limited to real-time GPS coordinates, altitude and battery life back to the PUD Routing Server 111.

After receiving the data transmission from all nearby Drones, Quadcopters, Helicopters and UAVs 113a, 113b and 113c available for deployment, with a ESN, SN, MID, Remote ID or FAA registration number and within the independent network, the PUD Routing Server 111 aircraft selection protocol process the minimum possible flight time and distance based on the current GPS coordinates and altitude of the take-off location, pick-up location and drop-off location, as well as the return to take-off or home location. Additionally, the deployment time, battery life and flight range of the make and model of available Drones, Quadcopters, Helicopters and UAVs 113a, 113b and 113c is processed after each Drone, Quadcopter, Helicopter and UAV transmit a data output signal 114a, 114b and 114c.

After the transaction flight details have been processed, the aircraft selection protocol will prioritize the Drone, Quadcopter, Helicopter or UAV 113a, 113b and 113c by registered ESN, SN, MID, Remote ID or FAA registration number best suited to complete the transaction. Aircraft selection protocol will prioritize the data retrieved from data output signals 114a, 114b and 114c, then process the criteria based on real-time data, including but not limited to aircraft no-fly zones, take-off location, pick-up location, drop-off location, home location, projected flight time, flight range and current battery life. After the PUD Routing Server 111 prioritizes the ESN, SN, MID, Remote ID or FAA registration number, the aircraft selection protocol will make a selection, subject to change prior to the transaction, whereby the PUD Routing Server 111 will transmit data output signal to the selected Drone, Quadcopter, Helicopter or UAV 113a, 113b and 113c. Simultaneously, the PUD Routing Server 111 will transmit data output signal 116 to the Sender 101 GUI and Receiver 105 GUI. Data output signal 116 will be transmitted onto the web-interfacing application and displayed onto the Sender 101 GUI and Receiver 105 GUI. Data displayed onto the Sender 101 and Receiver 105 GUIs will include, but not limited to the ESN, SN, MID, Remote ID or FAA registration number selected, pick-up time, flight time, delivery time and expected return to home or launch pad time.

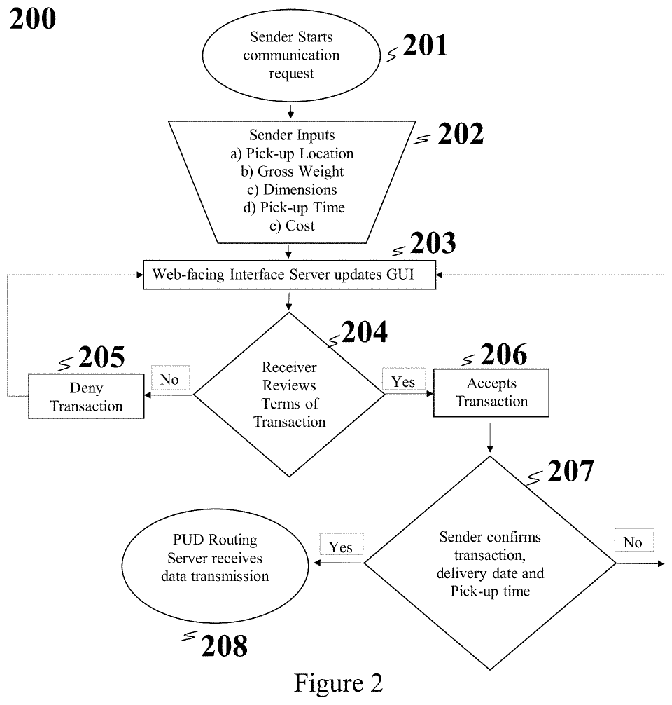

Referring now to FIG. 2, an improved methodology 200 that facilitates the deployment of an independent non-centralized registered autonomous aircraft including Drone, Quadcopter, Helicopter or UAV with an ESN, SN, MID, Remote ID or FAA registration number using the PUD application. The methodology begins at 201, where the transaction starts from the Sender 101 starting the communication request 201 from the GUI of the web-interfacing PUD application. The methodology transitions to the Sender 101 inputting the a) Pick-up Location, b) Gross Weight c) Dimensions d) Time e) Cost 202. The methodology then transitions to the Web-facing Interface Server 103 updating the GUI 203. The methodology then transitions to where the Receiver Reviews Terms of Transaction 204 as posted on the GUI. The methodology then transitions to Deny Transaction 205 if the Receiver 105 fails to accept the transaction. When the transaction is denied, no changes are made and the methodology transitions back to the Web-facing Interface Server updates GUI 203.

If the Receiver 105 approves of the transaction, the methodology transitions to Accepts Transaction 206. The methodology then transitions to the GUI of the web-interfacing PUD application, where the Sender 101 confirms transition, delivery date and time 207. If Sender 101 denies transaction delivery date and time, methodology transitions back to the Web-facing Interface Server updates GUI 203. If Sender 101 accepts delivery date and time, methodology transitions to PUD Routing Server receives data transmission 208.

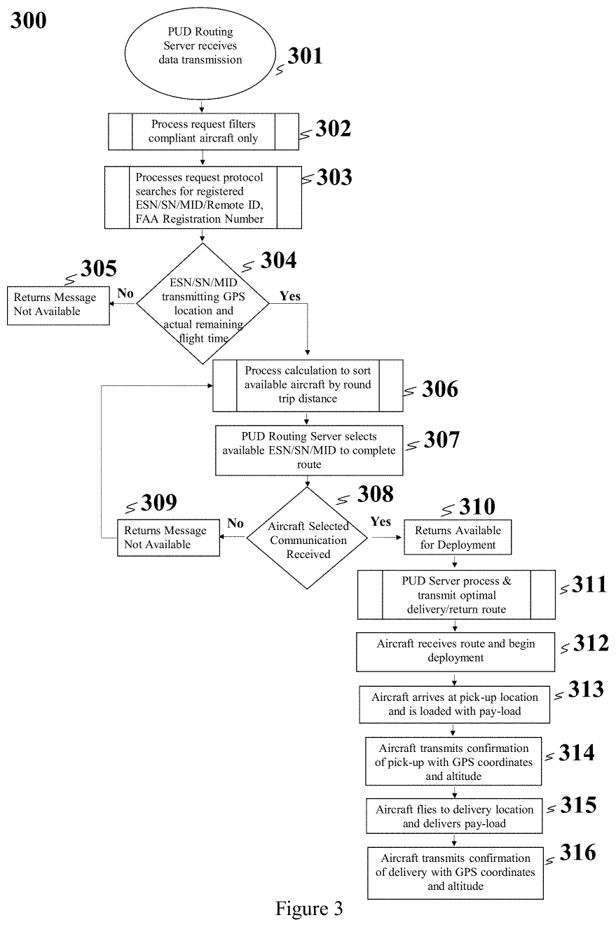

Referring now to FIG. 3, an improved methodology 300 that facilitates the selection of independent non-centralized autonomous aircraft with an ESN, SN, MID, Remote ID or FAA registration number. The methodology begins where the PUD Routing Server receives data transmission 301. The methodology transitions to a subroutine whereby a process request filters compliant aircraft only 302. Compliant aircraft includes all aircraft capable of completing the PUD route, selected by a set of physical qualifying specification criteria of the aircraft, including but not limited to make, model, gross weight, available flight time, max payload capacity, flight time, package size, battery amperage and hovering time.

The methodology transitions to existing compliant devices that have been filtered by maximum available flight time and maximum payload capacity based on model specification, whereby an aircraft selection protocol searches for available registered ESN, SN, MID, Remote ID or FAA registration number 303. Aircraft selection protocol starts by sending a transmission request to available registered ESN, SN, MID, Remote ID or FAA registration number in a defined area. The methodology transitions to the ESN, SN, MID, Remote ID or FAA registration number transmitting GPS location, altitude and actual remaining flight time 304. The methodology transitions to Returns Message Not Available 305 if no transmission is made, eliminating the ESN, SN, MID, Remote ID or FAA registration number from available units capable of being deployed. The methodology transitions to a subroutine whereby a process calculation to sort available aircraft by round trip distance 306 is performed. The process calculation performs an optimization by sorting available aircraft into a hierarchy of available aircraft capable for deployment based on minimum round-trip distance, having already filtered for current GPS location and actual remaining flight time.

The methodology transitions to the PUD Routing Server sending a route to nearest available ESN, SN, MID, Remote ID or FAA registration number 307 for confirmation of availability. The methodology then transitions to Aircraft Selection Communication Received 308. The methodology transitions to Returns Message Not Available 309 if communication between PUD Routing Server and aircraft identified by ESN, SN, MID, Remote ID or FAA registration number cannot be made. The methodology will transition back to Process calculation sort available aircraft by round trip distance 306, with the ESN, SN, MID, Remote ID or FAA registration number of the unit previously selected dropping off of the eligibility list of capable aircraft available for deployment.

If communication between PUD Routing Server 111 and aircraft identified by ESN, SN, MID, Remote ID or FAA registration number is received, the methodology transitions to the aircraft Returns Available for Deployment 310 back to the PUD Routing Server 111. Selected aircraft acknowledges the request and transmits signal back to the PUD Routing Server 111, along with the current GPS position and altitude. The methodology transitions to the PUD Routing Server process and transmit optimal delivery and return flight plan 311 to the selected aircraft. Selected aircraft receives the optimized flight route, with known obstacle avoidance.

The methodology transitions to Aircraft receives route and begin deployment 312. Aircraft begins the PUD optimized route by flying to the pick-up location. The methodology transitions to aircraft arrives at pick-up location and is loaded with payload 313. After being loaded with the payload at the pick-up location, the methodology transitions to the aircraft transmitting confirmation of pick-up with GPS coordinates and altitude 314. Aircraft will notify the PUD Routing Server 111 that pick-up has been completed along with the GPS location and altitude of the pick-up.

The methodology transitions to Aircraft flies to delivery location and delivers payload 315. While in transit, the optimized flight path avoids contact with known no-fly zones as transmitted by the PUD Routing Server 111. Also, the optimized flight path utilizes two-way aircraft communication using the ESN, SN, MID, Remote ID or FAA registration number communication for collision avoidance and flight path redirection when a nearby aircraft identified by an ESN, SN, MID, Remote ID or FAA registration number is detected wirelessly by the aircraft's internal or peripheral module in flight. The methodology transitions to Aircraft transmits confirmation of delivery with GPS coordinates and altitude 316. Confirmation transmission is sent back to the PUD Routing Server 111 signifying successful route completion.

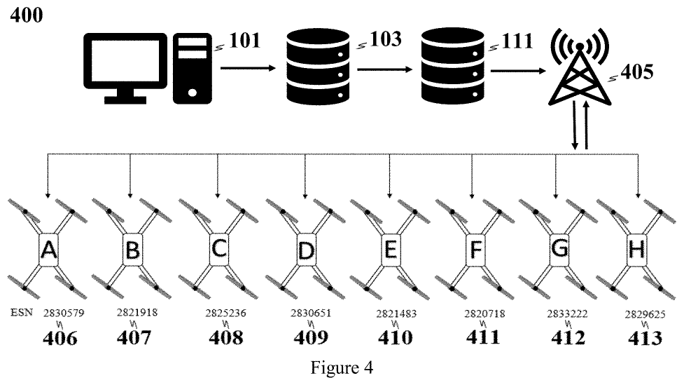

Referring now to FIG. 4, a flow diagram that includes a web-interfacing GUI hosted on a computer 401 or smartphone 402 used to initiate a transaction using the PUD application for an independent non-centralized registered autonomous aircraft with ESN, SN, MID, Remote ID or FAA registration number. Methodology transitions to the Web-interfacing Server 103 to record and confirm transaction details. After the transaction details have been confirmed, the methodology transitions to the PUD Routing Server 111. PUD Routing Server 111 then sends a request to the satellite, Wi-Fi or cellular tower 405 to ping all available aircraft 406, 407, 408, 409, 410, 411, 412 and 413.

After the aircraft responds to the ping with aircraft identifier ESN, SN or MID, Remote ID or FAA registration number, data including aircraft make, model, flight time, range and maximum payload, GPS location, altitude and actual remaining flight time 304 will be sent back to satellite, Wi-Fi or cellular tower 405. Methodology transitions when the PUD Routing Server 111 sends the aircraft identifier ESN, SN, MID, Remote ID or FAA registration number along with route instructions and flight path details to the satellite, Wi-Fi or cellular transmitter 405. The methodology transitions back to the PUD Routing Server 111 with the data obtained from the available aircraft responding to the initial ping. PUD Routing Server 111 then executes the aircraft selection protocol, determining the optimized ESN, SN, MID, Remote ID or FAA registration number available for deployment.

Methodology then transitions to the PUD Routing Server 111 transmitting the selected aircraft identified by ESN, SN, MID, Remote ID or FAA registration number from the aircraft selection protocol to the satellite, Wi-Fi or cellular antenna 405. The methodology transitions to the satellite, Wi-Fi or cellular antenna 405 transmitting the route details for the optimal delivery and return flight plan to one of the selected aircraft 406,407,408,409,410,411,412 or 413 identified by an ESN, SN, MID, Remote ID or FAA registration number.

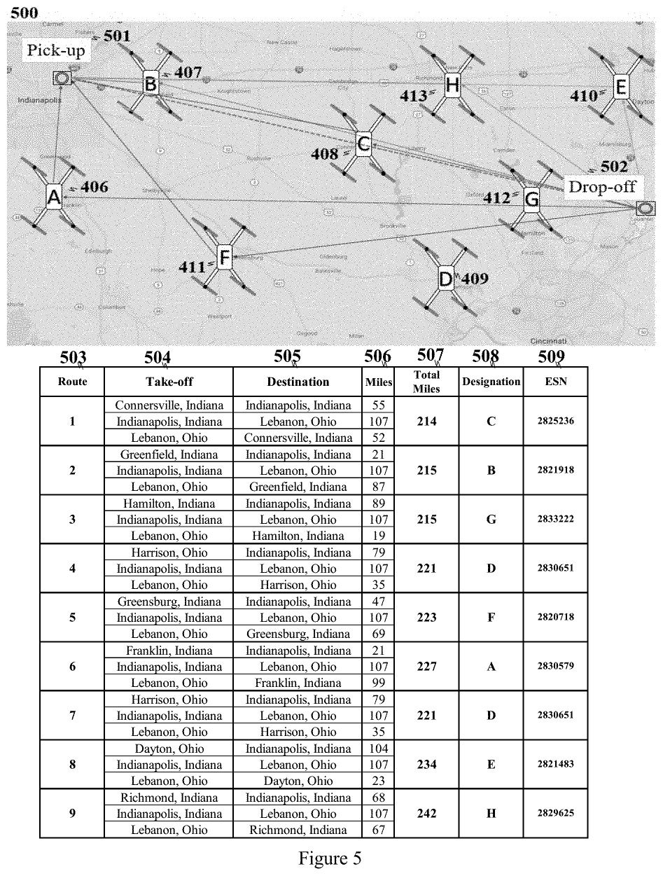

Referring now to FIG. 5, a graphic display 500 overlaid with a map of all nearby aircraft, communicating back to the initial transmittal request for GPS coordinates, emanating from the PUD Routing Server 111, suited to complete the transaction process by means of the aircraft selection protocol which also satisfy all the criteria for the deployment aircraft selection protocol. Starting at the Pick-up 501 location identifying the GPS coordinates and altitude of a parcel pick-up location and Drop-off 502 location identifying the GPS coordinates and altitude of a parcel drop-off point. In-between the Pick-up 501 and Drop-off 502 locations, a plurality of independent non-centralized registered autonomous aircraft including Drone, Quadcopter, Helicopter or UAV aircraft 407, 408, 409, 410, 411, 412 and 413 identified by an ESN, SN, MID, Remote ID or FAA registration number.

Below the overlaid map and starting with the individual data sent from the available aircraft is in one embodiment a route specific data set, stored in an aircraft selection database, located on the PUD Routing Server 111. The data set starts with a numerically sorted Route 503 field for each available Drone, Quadcopter, Helicopter or UAV aircraft identified by an ESN, SN, MID, Remote ID or FAA registration number is displayed. Each potential Route 503 displayed identifies three distinct Take-off 504 locations and three distinct Destination 505 locations. Take-off 504 and Destination 505 locations are comprised of three separate flight-paths; 1) aircraft current location to pick-up location, 2) pick-up location to destination location and 3) destination location to home location.

Each route denotes the three separate flight paths. The distance of each flight path is noted in miles 506 as processed by the deployment aircraft selection protocol. A cumulative distance denoted by Total Miles 507 represents the summation of the total Route 503 distance. This total distance traversed as a product of all three segmented flight paths is computed by the aircraft selection protocol. Additionally, a Designation 508 is denoted by an alphanumeric character to more easily visually identify the non-centralized independent autonomous aircraft on the graphic display 500. Also, the full ESN 509, SN, MID, Remote ID or FAA registration number may also be displayed.

Prioritization of aircraft selection in one embodiment is displayed in numerical order as seen under the heading Route 503 after the deployment aircraft selection protocol processes the individual routes in Miles 506 and sums up the flight path Total Miles 507. The aircraft selection database file format for a flight path data set may in another embodiment be hidden from the GUI display.

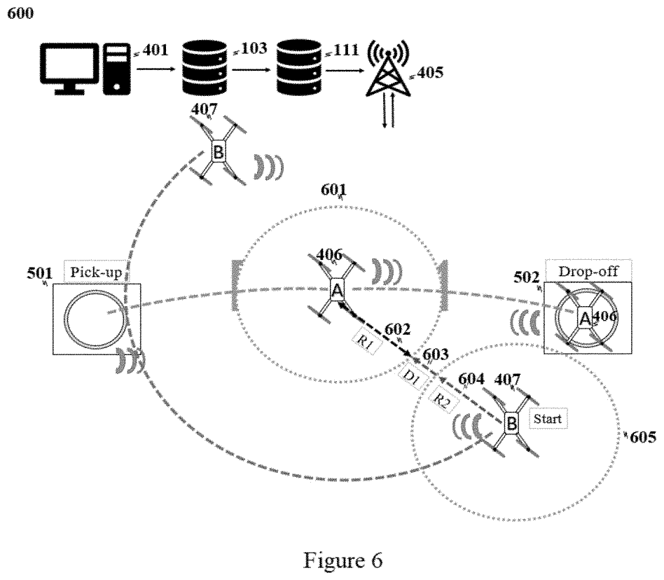

Referring now to FIG. 6, a functional block diagram 600 of route avoidance protocol by ESN, SN, MID, Remote ID or FAA registration number, starting with inputs received from a Web-interfacing Server 103, which receives sender and receiver user inputs. Web-interfacing Server 103 then transmits PUD routing instructions and flight path details onto the PUD Routing Server 111. PUD Routing Server 111 then processes the aircraft selection protocol and selects an aircraft for delivery out to a satellite, Wi-Fi or cellular transmitter 405. Satellite, Wi-Fi or cellular transmitter 405 then sends PUD route to the aircraft selected by the aircraft selection protocol. After the satellite, Wi-Fi or cellular transmitter 405 transmits the route delivery instructions to the selected aircraft, the aircraft begins the PUD delivery route.

In one embodiment, the selected aircraft A 406 begins take off from the Pick-up location 501. As aircraft A 406 travels along the flight path to Drop-off 502, an inter-network no-flight zone 601 will be continuously transmitted around a set radius R1 602 of aircraft A 406. In-route aircraft A 406 will transmit its ESN, SN, MID, Remote ID or FAA registration number along with GPS and altitude positioning to other nearby aircraft and back to the satellite, Wi-Fi or cellular transmitter 111, which then transmits back to the GPS Routing Server 111.

Nearby aircraft B 407 that are in-flight and have a flight path with distance of a set radius R2 603 away from entering the selected aircraft A 406 no-fly zone 601, will receive and transmit ESN, SN, MID, Remote ID or FAA registration number identification to and from aircraft A 406. Positive identification of another aircraft B 407 nearby will simultaneously transmit the nearby ESN, SN, MID, Remote ID or FAA registration number along with GPS and altitude positioning out to the satellite, Wi-Fi or cellular transmitter 405, which then transmits the aircraft B 407 position back to the PUD Routing Server 111. When the PUD Routing Server 111 receives a transmission from aircraft A 406 and aircraft B 407 with GPS and altitude positioning along with the known flight path, identified by ESN, SN, MID, Remote ID or FAA registration number, the flight path prioritization protocol will initiate.

Flight path prioritization and subsequent secondary flight path will be processed within the PUD Routing Server 111. Flight path prioritization protocol requires an aircraft's ESN, SN, MID, Remote ID or FAA registration number to identify a singular or plurality of aircraft near the flight path of another aircraft similarly identified by ESN, SN, MID, Remote ID or FAA registration number. After positively identifying the aircraft along with the GPS and altitude positioning with known flight path, the flight path prioritization protocol computes a hierarchy for route paths. This hierarchy assigns route precedence for an individual aircraft as identified by ESN, SN, MID, Remote ID or FAA registration number. Alternatively, aircraft identified with lower order priority will yield the current flight path and receive a secondary flight path.

In some embodiments, all aircraft identified by an ESN, SN, MID, Remote ID or FAA registration number will receive a transmission emanating from a satellite, Wi-Fi or cellular tower 405 as received from the PUD Routing Server 111 with a lower order priority. In such an embodiment all lower order priority in-network aircraft will receive a secondary route path instruction, altering all in-flight aircraft without regard to a hierarchal construct.

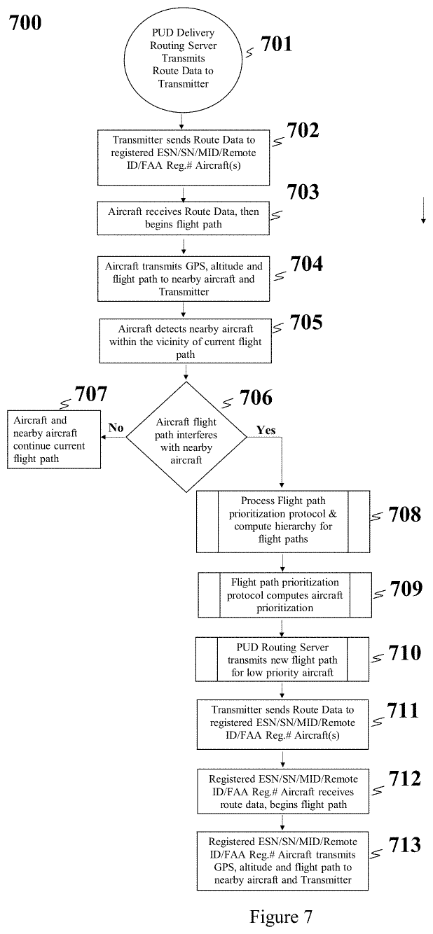

Referring now to FIG. 7, a functional block diagram of an exemplary system 700 that facilitates the flight path prioritization protocol. Methodology starts with the PUD Delivery Routing Server Transmits Route Data to Transmitter 701 and out to an aircraft identified by the registered ESN, SN, MID, Remote ID or FAA registration number, selected by the aircraft selection protocol. The satellite, Wi-Fi or cellular transmitter 405 sends route data to registered ESN, SN, MID, Remote ID or FAA registration number aircraft(s) 702. The aircraft receives route data, then begins flight path 703. When aircraft begins flight path, the aircraft transmits GPS, altitude and flight path to nearby aircraft and transmitter 704. The current route path of the selected aircraft will continue without interruption until the aircraft detects nearby aircraft within the vicinity of the current flight path 705. If nearby aircraft are detected, a computation will be made regarding if the current aircraft flight path interferes with nearby aircraft 706. If the aircraft flight path does not interfere with nearby aircraft, aircraft and nearby aircraft continue current flight path 707. If the aircraft flight path interferes with nearby aircraft, the PUD Routing Server 111 will process flight path prioritization protocol and compute hierarchy for flight paths 708. After identifying the hierarchy for flight paths, the flight path prioritization protocol computes aircraft prioritization 709. Aircraft prioritization protocol identifies if an aircraft is to stay on its current flight path or change flight path based on the priority of the current flight path of the aircraft in progress of making the delivery.

After the flight path prioritization protocol computes aircraft prioritization 709, PUD Routing Server 111 transmits new flight path for low priority aircraft 710 out to a transmitter. The transmitter sends route data to registered ESN, SN, MID, Remote ID or FAA registration number aircraft(s) 711. The registered ESN, SN, MID, Remote ID or FAA registration number aircraft(s) receives route data, begins flight path 712. After receiving the new flight path instructions, registered aircraft transmits GPS, altitude and flight path to nearby aircraft and Transmitter 713.

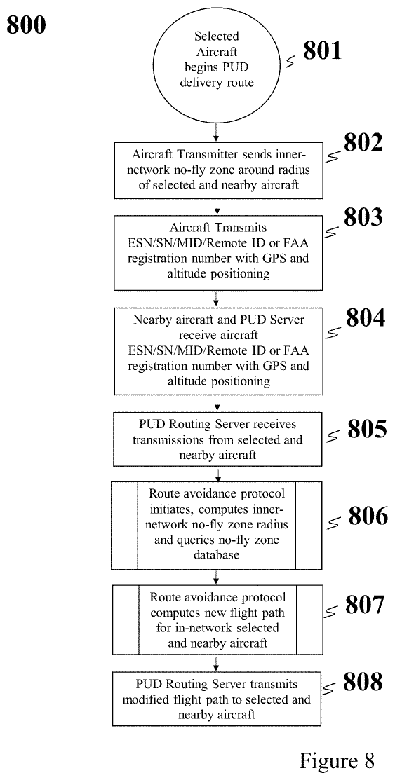

Referring now to FIG. 8, a functional block diagram of an exemplary system 800 that facilitates the route avoidance protocol. Methodology starts with selected aircraft begins PUD delivery route 801. As the selected aircraft starts its flight plan, the aircraft transmitter sends inner-network no-fly zone around radius of aircraft 802. Methodology transitions to aircraft transmits ESN, SN, MID, Remote ID or FAA registration number with GPS and altitude positioning 803. Methodology then transitions to nearby aircraft and PUD server receive aircraft ESN, SN, MID, Remote ID or FAA registration number with GPS and altitude positioning 804. Methodology transitions to PUD routing server receives transmissions from selected and nearby aircraft 805.

After receiving the transmissions from selected and nearby aircraft 805, the first sub-routine of the route avoidance protocol computes inner-network no-fly zone radius and queries no-fly zone database 806. The methodology transitions to the second sub-routine, whereby the route avoidance protocol computes new flight path for in-network selected and nearby aircraft 807. The methodology then transitions to the PUD routing server transmits modified flight path to selected and nearby aircraft 808.

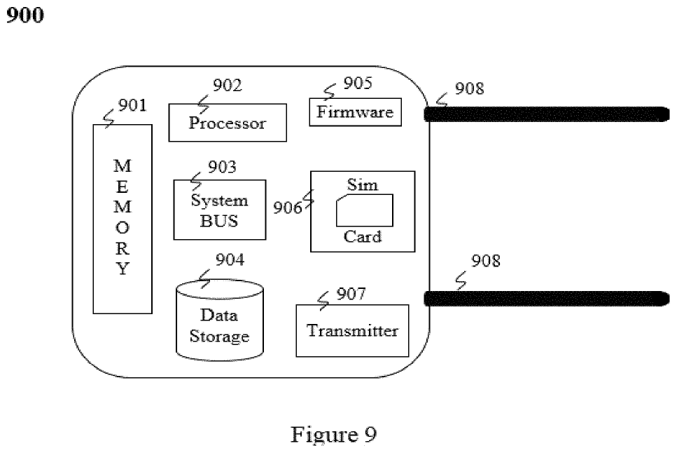

Referring now to FIG. 9, an internal or peripheral module 900 mounted to an independent non-centralized registered autonomous Drone, Quadcopter, Helicopter or UAV capable of wirelessly transmitting and receiving GPS positioning, altitude positioning, PUD routing instructions, route avoidance, Aircraft to Aircraft (ATA) identification and aircraft Communications Addressing and Reporting System (ACARS). Peripheral module 900 is equipped with an ESN, SN, MID, Remote ID or FAA registration number capable of wirelessly transmitting its identification.

Peripheral module 900 includes Memory 901 to store the ESN, SN, MID, Remote ID or FAA registration number. Also included with the peripheral module is the Processor 902 to process the PUD routing, flight path, ATA identification and ACARS communication. A System Bus 903 to connect the major components housed within the peripheral module 900 also acts to communicate between the Drone, Quadcopter, Helicopter or UAV. Additionally, internal or peripheral module 900 also includes Data Storage 904, Firmware 905 and a Sim card 906 reader and writer. Internal or peripheral module 900 also includes an Altimeter 907 to measure the height above ground to be used when transmitting GPS positional data and PUD Routing plan. Antennas 908 are also equipped to receive and transmit data to and from the internal or peripheral device.

What is claimed is:

1. An improved system for a Pick-up and Delivery (PUD) application for transportation using a plurality of independent non-centralized registered autonomous aircraft identified by an Electronic Serial Number (ESN), Serial Number (SN), Manufacturer Identification Number (MID), Remote ID or FAA registration number, comprising;
an improved internet facing web-based PUD application for use with independent non-centralized registered autonomous aircraft including Drones, Quadcopters, Helicopters or UAVs, consisting of a graphic user interface (GUI) receiving user inputs by a sender including pick-up location, package gross weight, package dimensions and pick-up time availability;
responsive to a primary user or sender providing user inputs including pick-up location, package gross weight, package dimensions and pick-up time availability, a web-interfacing server receiving, storing and transmitting user inputs;
responsive to a web-interfacing server receiving, storing and transmitting user inputs, a secondary user or receiver confirming transaction, delivery date, pick-up time and transaction costs;
responsive to a receiver confirming transaction, delivery date, pick-up time and transaction costs, the web-interface server receiving, storing and transmitting the receiver inputs;
responsive to the web-interface server receiving, storing and transmitting the receiver inputs, the sender reconfirms transaction inputs including, delivery date, pick-up time and transaction costs out to the web-interface server and out to the PUD routing server;
responsive to the sender reconfirms transaction inputs including, delivery date, pick-up time and transaction costs out to the web-interface server and out to the PUD routing server; a PUD routing server processing request filters for registered compliant aircraft, including but not limited to make, model, gross weight, hovering time, available flight time, max payload capacity, max package size, battery amperage and total flight distance;
responsive to a PUD routing server processing request filters for registered compliant aircraft including but not limited to make, model, gross weight, hovering time, available flight time, max payload capacity, max package size, battery amperage and total flight distance, a PUD routing server determining ESN, SN, MID, Remote ID or FAA registration number within a defined radius of the last reported GPS coordinates for all compliant aircraft;
responsive to a PUD routing server determining ESN, SN, MID, Remote ID or FAA registration number within a defined radius of the last reported GPS coordinates for all compliant aircraft, a PUD routing server sending requests to satellite, Wi-Fi or cellular towers pinging all available aircraft with a registered ESN, SN, MID, Remote ID or FAA registration number;
responsive to a PUD routing server sending requests to satellite, Wi-Fi or cellular towers pinging all available aircraft with a registered ESN, SN, MID, Remote ID or FAA registration number, a plurality of registered aircraft transmitting current GPS location, altitude, flight time remaining, battery amperage and hovering time remaining out to a satellite, Wi-Fi or cellular towers;
responsive to a plurality of registered aircraft transmitting current GPS location, altitude, flight time remaining, battery amperage and hovering time remaining out to a satellite, Wi-Fi or cellular towers, the satellite, Wi-Fi or cellular towers sending aircraft data back to the PUD routing server;
responsive to the satellite, Wi-Fi or cellular towers sending aircraft data back to the PUD routing server, the PUD routing server running an aircraft selection protocol and selecting an independent non-centralized registered autonomous aircraft including Drone, Quadcopter, Helicopter or UAV identified by an ESN, SN, MID, Remote ID or FAA registration number;
responsive to the PUD routing server running an aircraft selection protocol and selecting an independent non-centralized registered autonomous aircraft including Drone, Quadcopter, Helicopter or UAV identified by an ESN, SN, MID, Remote ID or FAA registration number, the aircraft confirms availability for deployment;
responsive to the aircraft confirms availability for deployment, PUD routing server processes and transmits optimal delivery and return route;
responsive to PUD routing server processes and transmits optimal delivery and return route, aircraft begins deployment, aircraft arrives at pick-up location and is loaded with pay-load;
responsive to aircraft arrives at pick-up location and is loaded with pay-load;
aircraft transmits confirmation of package pick-up including GPS coordinates and altitude back to the PUD routing server;
responsive to the aircraft transmits confirmation of package pick-up including GPS coordinates and altitude back to the PUD routing server, aircraft flies to delivery location and delivers pay-load;
responsive to the aircraft flies to delivery location and delivers pay-load, aircraft transmits confirmation of delivery with GPS coordinates and altitude.

2. The system of claim 1, wherein a GUI displays an aircraft selection protocol prioritization data set and map comprising;
a plurality of routes displayed in numerical order comprising;
distinct flight paths with take-off and destination locations overlaid on a geographic map; and
individual flight path distance measured in miles; and
a summation in total miles for the plurality of individual flight paths within a singular route; and
an alphanumeric character designation to identify an aircraft for graphic display; and
an ESN, SN, MID, Remote ID or FAA registration number.

3. The system of claim 1, wherein an aircraft identification protocol stored onto a pick-up and delivery routing server, aircraft internal module or aircraft peripheral module facilitates the identification of an independent non-centralized registered autonomous aircraft identified by an ESN, SN, MID, Remote ID or FAA registration number, comprising;
a memory with a database or readable file comprising;
a plurality of independent non-centralized registered autonomous aircraft identified by a unique identifier including ESN, SN, MID, Remote ID or FAA registration number with associated specification data including, but not limited to make, model, gross weight, aircraft payload capacity, maximum aircraft flight time, current aircraft battery amperage and maximum hovering time; and
all known unique character identifiers for manufactured aircraft including unique post-manufacturing identification characters with associated data including aircraft payload capacity, maximum aircraft flight time, current aircraft battery amperage and maximum hovering time;
a processor with a routine configured to;
compute a payload capacity, maximum aircraft flight time remaining, current aircraft battery amperage, maximum hovering time remaining and a no-fly zone around the GPS coordinates and altitude of the aircraft in flight;
a sub-routine configured to receive the unique aircraft identifier including ESN, SN, MID, Remote ID or FAA registration number of nearby aircraft transmitted and query the database located on the memory; and
decode the unique aircraft identifier characters to identify make, model, gross weight, available flight time, max payload capacity, flight time, battery amperage and hovering time.

4. A system for an aircraft selection protocol from a plurality of independent non-centralized registered autonomous aircraft identified with a registered ESN, SN, MID, Remote ID or FAA registration number comprising;
a wired or wireless PUD routing server to receive and transmit data comprising;
user defined inputs including, but not limited to pick-up GPS location, altitude, package gross weight, packaged dimensions and pick-up time availability; and
aircraft transmitted data including, but not limited to ESN, SN, MID, Remote ID or FAA registration number;
a memory with a database or readable file comprising;
a plurality of independent non-centralized registered autonomous aircraft identified by an ESN, SN, MID, Remote ID or FAA registration number with associated data including, but not limited to aircraft payload capacity,
maximum aircraft flight time, current aircraft battery amperage and maximum hovering time;
a processor with a routine configured to;
compute user input data for total distance between pick-up GPS location and delivery GPS location; and
query received user input data including, but not limited to pick-up GPS location, delivery GPS location, total computed distance between pick-up GPS location and drop-off GPS location, total package gross weight, packaged dimensions and pick-up time availability from a memory stored database or readable file comprising aircraft specification data including, but not limited to a registered ESN, SN, MID, Remote ID or FAA registration number, make, model, gross weight, available flight time, max payload capacity, flight time, battery amperage and hovering time; and
filter aircraft identified by registered ESN, SN, MID, Remote ID or FAA registration number whose specifications meet or exceed the user input data including, but not limited to total computed distance between pick-up GPS location and drop-off GPS location, total package gross weight, packaged dimensions and pick-up time availability; and
transmit a data return request or ping out to all filtered aircraft from memory stored database or readable file identified by registered aircraft identified by an ESN, SN, MID, Remote ID or FAA registration number for current GPS location, flight time remaining, battery amperage remaining and hovering time remaining; and
if aircraft selection communication is not received by an aircraft, return message not available; or
if aircraft selection communication is received by an aircraft, return ESN, SN, MID, Remote ID or FAA registration number and current GPS location, altitude, flight time remaining, battery amperage remaining and hovering time remaining; and
a secondary sub-routine configured to numerically prioritize total PUD routes by total miles computed by route distance for sorted aircraft identified by ESN, SN, MID, Remote ID or FAA registration number; and
select highest prioritized route identified by ESN, SN, MID, Remote ID or FAA registration number available by PUD round trip distance; and
transmit PUD route request to highest prioritized aircraft identified by ESN, SN, MID, Remote ID or FAA registration number; and
if aircraft selected communication received does not receive communication, PUD server returns message not available; or
if aircraft selected communication receives request, aircraft selected transmits Returns Available for Deployment; and
a third sub-routine configured to transmit optimal delivery and return route to the selected aircraft; where
aircraft receives route and begins deployment; and
arrives at pick-up location and is loaded with payload; and
transmits confirmation of pick-up with GPS coordinates and altitude; and
flies to delivery location and delivers payload; and
transmits confirmation of delivery with GPS coordinates and altitude.

5. A system for an aircraft flight path prioritization protocol to assign prioritization from a plurality of independent non-centralized registered autonomous aircraft identified with a registered ESN, SN, MID, Remote ID or FAA registration number comprising;
a wired or wireless PUD routing server to receive and transmit data comprising;
user defined inputs including, but not limited to pick-up GPS location, package gross weight, packaged dimensions and pick-up time availability;
aircraft transmitted data including, but not limited to ESN, SN, MID, Remote ID or FAA registration number;
a memory with a database or readable file comprising;
a plurality of independent non-centralized aircraft identified by a registered compliant ESN, SN, MID, Remote ID or FAA registration number with associated data including, no-fly zones, restricted areas, prohibited and temporary flight restriction zones;
a processor with a routine configured to;
transmit route data to registered aircraft identified by ESN, SN, MID, Remote ID or FAA registration number;
responsive to transmit route data to registered aircraft identified by ESN, SN, MID, Remote ID or FAA registration number, registered aircraft begins flight path;
responsive to registered aircraft begins flight path, registered aircraft transmits current position GPS, altitude and flight path to nearby aircraft continually during flight;
responsive to registered aircraft transmits current position, GPS, altitude and flight path to nearby aircraft continually during flight, aircraft detects nearby registered compliant aircraft identified by an ESN, SN, MID, Remote ID or FAA registration number within a set area of current flight path;
responsive to aircraft detects nearby registered compliant aircraft identified by an ESN, SN, MID, Remote ID or FAA registration number within a set area of current flight path, compute a no-fly zone around the GPS coordinates and altitude of the aircraft in flight and nearby aircraft;
responsive to compute a no-fly zone around the GPS coordinates and altitude of the aircraft in flight and nearby aircraft, if aircraft selected flight path does not interfere with nearby aircraft, selected aircraft and nearby aircraft continue current flight path; or
responsive to compute a no-fly zone around the GPS coordinates and altitude of the aircraft in flight and nearby aircraft, if aircraft selected flight path does interfere with nearby aircraft, initiate a series of sub-routines;
responsive to initiate a series of sub-routines, a sub-routine configured to compute hierarchy for flight paths of nearby aircraft identified by a registered compliant ESN, SN, MID, Remote ID or FAA registration number; and
a second sub-routine configured to numerically prioritize aircraft identified by a registered compliant ESN, SN, MID, Remote ID or FAA registration number; and
a third sub-routine configured to create new flight path for low priority aircraft;
responsive to a third sub-routine configured to create a new flight path for low priority aircraft; new flight path route data is sent to registered aircraft identified by ESN, SN, MID, Remote ID or FAA registration number;
responsive to new flight path route data is sent to registered aircraft identified by ESN, SN, MID, Remote ID or FAA registration number, aircraft receives new route data and begins flight path;
responsive to aircraft receives new route data and begins flight path, registered aircraft identified by ESN, SN, MID, Remote ID or FAA registration number transmits GPS coordinates, altitude and flight path to nearby aircraft and transmitter;

6. A system for a route avoidance protocol to compute an inner-network no-fly zone and identify a known FAA no-fly zone for a plurality of independent non-centralized autonomous aircraft identified with a registered ESN, SN, MID, Remote ID or FAA registration number comprising;
a plurality of independent non-centralized registered autonomous aircraft equipped with an internal or peripheral module to transmit and receive a unique aircraft identifier including an ESN, SN, MID, Remote ID or FAA registration number;
a wired or wireless PUD routing server facilitating transmitting and receiving data comprising;
a memory with a database or readable file comprising;
storing a plurality of independent non-centralized registered autonomous aircraft by a registered compliant ESN, SN, MID, Remote ID or FAA registration number with associated data including, no-fly zones, restricted areas, prohibited zones and temporary flight restriction zones;
a processor with a routine configured to create an inner network no-fly zone radius around an aircraft and recognize existing FAA no-fly zones;
receive inner-network ESN, SN, MID, Remote ID or FAA registration number with GPS and altitude positioning; and
compute an inner network no-fly zone radius around the GPS coordinates and altitude of all in-network aircraft identified by an ESN, SN, MID, Remote ID or FAA registration number; and
query FAA no-fly zone database with data including, no-fly zones, restricted area, prohibited zone and temporary flight restriction zone; and
a sub-routine configured to create and transmit a new flight path for aircraft entering an in-network or FAA no-fly zone; and
recognize when aircraft GPS position, altitude and flight path will enter a restricted area, prohibited, temporary flight restriction zone, in-network or FAA no-fly zone; and
compute new flight path for selected and nearby in-network aircraft identified by an ESN, SN, MID, Remote ID or FAA registration number; and
transmit new flight path route to registered aircraft identified by an ESN, SN, MID, Remote ID or FAA registration number.
